(19) United States
(12) Patent Application Publication
(10) Pub. No.: US 2015/0036720 A1
(43) Pub. Date: Feb. 5, 2015

(54) METHOD AND DEVICE FOR ASCERTAINING A SURFACE TEMPERATURE OF A SHEATHED-ELEMENT GLOW PLUG IN AN INTERNAL COMBUSTION ENGINE

(71) Applicant: ROBERT BOSCH GMBH, Stuttgart (DE)

(72) Inventor: Peter Kappelmann, Stuttgart (DE)

(21) Appl. No.: 14/354,737

(22) PCT Filed: Oct. 15, 2012
(86) PCT No.: PCT/EP2012/070416

§ 371 Date: Apr. 28, 2014

(30) Foreign Application Priority Data
Oct. 28, 2011 (DE) 10 2011 085 435.5

(51) Int. Cl. F02P 19/02; G01K 7/00

(52) U.S. Cl. CPC F02P 19/02; G01K 7/00
USPC 374/163

(57) ABSTRACT

A method is described for ascertaining a surface temperature of a sheathed element glow plug in an internal combustion engine, in which a physical parameter is utilized for ascertaining the surface temperature. In order to be able to ascertain a precise surface temperature at a reduced outlay in terms of computation and development, at least two physical parameters of only the sheathed element glow plug are used for ascertaining the surface temperature of the sheathed element glow plug.

### FIELD OF THE INVENTION

The present invention relates to a method for ascertaining a surface temperature of a sheathed-element glow plug in an internal combustion engine, in which a physical parameter is utilized to ascertain the surface temperature; it also relates to a device for implementing the method.

### BACKGROUND INFORMATION

Sheathed element glow plugs, which are used in internal combustion engines for the purpose of igniting a fuel-air mixture, have a heater, which preheats the cold sheathed element glow plug to a temperature that is sufficient to ignite the fuel air mixture. However, from the heater to the entire sheathed element glow plug, the distribution of the temperature is quite inhomogeneous, so that temperature differences arise between the temperature of the heater, which is situated in the interior of the sheathed element glow plug, and the temperature at the surface of the sheathed element glow plug.

Since the sheathed element glow plug projects into the combustion chamber of the internal combustion engine, the surface of the sheathed element glow plug is invariably cooled by the fuel-air mixture that flows past the sheathed element glow plug in a dynamic operation of the internal combustion engine; as a result, the surface of the sheathed element glow plug never has the same temperature as the heater in the interior of the sheathed element glow plug.

If the temperature of the sheathed element is to be subjected to a closed-loop control, this is done as a function of the resistance of a heater in the interior of the sheathed element glow plug, from which the control actual value of the temperature is determined The higher the temperature of the heater, which is developed as a current-carrying wire, the higher the resistance. Because of the arising temperature differential, the quality of the closed-loop control of the temperature of the sheathed element glow plug is insufficient, inasmuch as it is not based on a temperature actually prevailing at the surface of the sheathed element glow plug.

German Published Patent Appln. No. 10 2009 047 650 discloses a method for ascertaining a temperature of a sheathed element glow plug in an internal combustion engine; in this method a temperature differential between the temperature of the sheathed element glow plug at a location outside the heater and the temperature at the heater of the sheathed element glow plug is ascertained as a function of the operating parameters of the internal combustion engine. This approach requires a considerable amount of computing capacity and developmental investment.

### SUMMARY

The present invention is based on the objective of providing a method and a device for ascertaining a surface temperature of a sheathed element glow plug in an internal combustion engine, in which a precise surface temperature is ascertainable at a reduced computational and developmental outlay.

According to the present invention, this objective is achieved by utilizing at least two physical parameters of solely the sheathed element glow plug for determining the surface temperature of the sheathed element glow plug. This has the advantage that it is possible to dispense with non-specific statements, caused by using the partially merely estimated operating parameters of the internal combustion engine, which results in a simplified application and a more robust behavior of the functionality. Using physical parameters that relate solely to the sheathed element glow plug reduces the development work involved in determining the surface temperature of the sheathed element glow plug. A precise determination of the surface temperature of the sheathed element glow plug is therefore possible both in a nonsteady state and in a steady state operation of the sheathed element glow plug. Applications are possible without the use of an additional thermo-element, which serves as measuring element for the surface temperature and is disposed at the sheathed element glow plug.

In an advantageous manner, at least one of the at least two physical parameters for determining the surface temperature of the sheathed glow plug is measured at the sheathed element glow plug, during its operation. Since the actual operating state of the sheathed element glow plug is taken into account when ascertaining the surface temperature, via its actual physical parameters, the precision of the surface temperature ascertained in this manner is increased.

In one development, at least one of the two physical parameters of the sheathed element glow plug is calculated using at least one further physical parameter, which is measured at the sheathed element glow plug during its operation. This ensures that the calculated physical parameter always has a direct relationship to the current operating state of the sheathed element glow plug, so that accurate surface temperatures are ascertained, which are derived from the actual operating parameters of the sheathed element glow plug.

Furthermore, the at least one calculated physical parameter is stored in a characteristics map, and this at least one physical parameter is read out from the characteristics map in order to calculate the surface temperature of the sheathed element glow plug. This indirect ascertaining of the surface temperature makes it possible to determine the characteristics map for the individual sheathed element glow plug just once, whereupon it may be used for determining the surface temperature at any time while the sheathed element glow plug is in operation.

In one further development, a resistance of the sheathed element glow plug and/or a power withdrawn by the sheathed element glow plug and/or an actual current of the sheathed element glow plug and/or a voltage of the sheathed element glow plug are/is used as the at least two physical parameters. By selecting two of these physical parameters, it is possible to ascertain the surface temperature of the sheathed element glow plug in a simple and reliable manner.

In one variant, the resistance of the sheathed element glow plug and/or the power drawn by the sheathed element glow plug are/is calculated based on the measured current and the measured voltage at the sheathed element glow plug. As a result, only two physical variables need to be measured at the sheathed element glow plug, from which further physical parameters of the sheathed element glow plug are then able to be determined This reduces the measuring work considerably.

In one further specific development, the ascertained surface temperature is corrected using a correction factor, which is a function of at least one operating parameter of the internal combustion engine, in particular. The correction of the surface temperature takes into account that the sheathed element glow plug is cooled when the internal combustion engine is in operation. The correction factor compensates for the discrepancy, which comes about because the surface temperature no longer has a linear relationship to the temperature of the heater disposed in the interior of the sheathed element glow plug.

Preferably, a rotational speed and/or an injection quantity and/or an air mass and/or a charge pressure of the air mass of the internal combustion engine are/is utilized as operating parameters. Taking these operating parameters of the internal combustion engine into account allows a precise correction of the surface temperature, since these parameters represent the actual ambient conditions of the sheathed element glow plug inside the internal combustion engine. No additional expense in terms of hardware is necessary to obtain these measured data, since these operating parameters are detected also for the purpose of analyzing other situations of the internal combustion engine.

In one further refinement, the ascertained surface temperature of the sheathed element glow plug is used as an actual temperature for a temperature control of the sheathed element glow plug. This temperature control is advantageous especially in the non-steady state operation of the sheathed element glow plug. Because the surface temperature is determined with the utmost precision, the quality of the closed loop control is improved.

One further refinement of the present invention relates to a device for ascertaining a surface temperature of a sheathed element glow plug in an internal combustion engine; this device uses a physical parameter to ascertain the surface temperature. In order to determine a precise surface temperature with a reduced outlay in terms of computation and development, an arrangement is provided which uses at least two physical parameters of only the sheathed element glow plug for ascertaining the surface temperature of the sheathed element glow plug. This offers the advantage that the surface temperature is able to be determined in an especially uncomplicated yet precise manner Under the varying conditions in the method of operation of the internal combustion engine and the therefore varying properties of the sheathed element glow plug, the surface temperature is determined in a simple manner with the aid of a device that is available in the motor vehicle anyway.

A control unit is advantageously connected to a sheathed element glow plug, which projects into a combustion chamber of the internal combustion engine, the control unit ascertaining the at least two physical parameters. The surface temperature thus determined in a highly precise manner by the control unit is able to be analyzed for a closed-loop or open-loop control of the temperature.

The present invention allows numerous specific embodiments. One of them will be explained in greater detail on the basis of the figures shown in the drawing.

### BRIEF DESCRIPTION OF THE DRAWINGS

FIG. 1 shows a schematic diagram of the setup of a sheathed element glow plug in an internal combustion engine.

FIG. 2 shows a schematic flow chart for ascertaining the surface temperature of a sheathed element glow plug.

### DETAILED DESCRIPTION

Cold internal combustion engines, especially diesel engines, require a starting aid at ambient temperatures of <40 degrees Celsius in order to ignite the fuel-air mixture supplied into the diesel engine. Glow systems, which consist of sheathed element glow plugs, a glow control unit and preheating software stored in an engine management system, are used as starting aid.

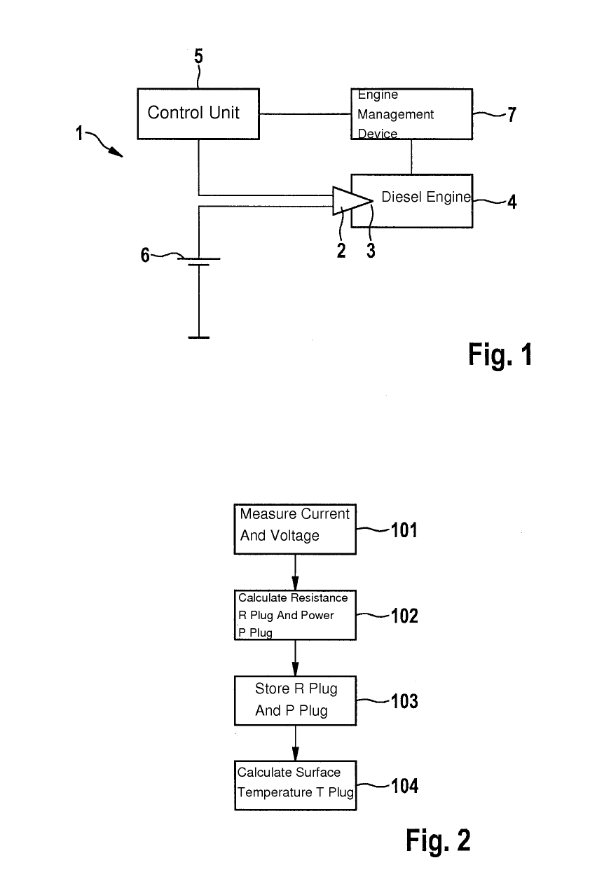

FIG. 1 shows such a glow system 1. A sheathed element glow plug 2 projects into combustion chamber 3 of diesel engine 4. On one side, sheathed element glow plug 2 is connected to glow control unit 5, and on the other side it leads to a vehicle system voltage 6, which controls sheathed element glow plug 2 with a nominal voltage of 11 Volt, for example. Glow control unit 5 is connected to engine management device 7, which in turn leads to diesel engine 4.

To ignite the fuel-air mixture, sheathed element glow plug 2 is preheated by applying an overvoltage in a push phase, which lasts 1 to 2 seconds. A heater (not shown further) of sheathed element glow plug 2 converts the electrical energy supplied to sheathed element glow plug 2 in this manner into heat. The temperature at the tip of sheathed element glow plug 2 rises steeply in the process. The heating output of the heater is adapted to the demands of individual diesel engine 4 with the aid of electronic glow control device 5.

The fuel-air mixture is directed past the hot tip of sheathed element glow plug 2 and heated. At the same time, the tip of sheathed element glow plug 2 cools down. The ignition temperature is reached in combination with the heating of the intake air during the compression cycle of diesel engine 4.

For applications of the combustion processes taking place in diesel engine 4, it is necessary to have knowledge of precise surface temperature T_{plug} of sheathed element glow plug 2. The determination of surface temperature T_{plug} will be explained with the aid of the flow chart in FIG. 2. In block 101, a current and a voltage are measured at sheathed element glow plug 2. In block 102, this current and voltage are used to calculate resistance R_{plug} of sheathed element glow plug 2 and power P_{plug} drawn by the sheathed element glow plug. These calculated values, resistance R_{plug} of sheathed element glow plug 2 and power P_{plug} currently drawn by sheathed element glow plug 2, are stored in a characteristics map in block 103. Using this calculated resistance R_{plug} of sheathed element glow plug 2 and power P_{plug} currently drawn by sheathed element glow plug 2, surface temperature T_{plug} is calculated. The mathematical relationships is as follows:

T_{plug}=T_{plug} (R_{plug}, P_{plug}).

In block 104, surface temperature T_{plug} calculated in block 103 is corrected because sheathed element glow plug 2 is cooled while diesel engine 4 is in operation and surface temperature T_{plug} no longer has a linear relationship with the temperature of the heater during the engine operation. The following relationship therefore results for ascertaining surface temperature T_{plug}:

T_{plug}=T_{plug} (R_{plug}, P_{plug})+ΔT (q, n, mₐᵢᵣ, . . . ).

Surface temperature T_{plug} of sheathed element glow plug 2 is corrected as a function of, for example, engine speed n, intake air mass mₐᵢᵣ or charge pressure T of the air mass. The precision of surface temperature T_{plug} of sheathed element glow plug 2 is improved when utilizing these operating parameters of diesel engine 4.

A less complicated and more reliable determination of surface temperature T_{plug} of sheathed element glow plug 2 is possible based on this procedure, without any significant computational work. The correction of surface temperature T_{plug} of sheathed element glow plug 2 via engine speed n, intake air mass mₐᵢᵣ, injection quantity q etc. is necessary only in exceptional cases, since the determination of surface temperature T_{plug} of sheathed element glow plug 2 by way of at least two physical parameters of solely sheathed element glow plug 2 is already very precise.

The ascertaining of surface temperature T_{plug} of sheathed element glow plug 2 is not restricted to the combination of resistance R_{plug} of sheathed element glow plug 2 and power P_{plug} currently drawn by sheathed element glow plug 2. A multitude of other combinations is conceivable, such as resistance R_{plug} of sheathed element glow plug 2 and the voltage of sheathed element glow plug 2, or resistance R_{plug} of sheathed element glow plug 2 and the current of sheathed element glow plug 2. Decisive is that the physical variables used for ascertaining surface temperature T_{plug} of sheathed element glow plug 2 are able to be traced back solely to the particular operating state of sheathed element glow plug 2 itself.

1.-11. (canceled)

12. A method for ascertaining a surface temperature of a sheathed element glow plug in an internal combustion engine in which a physical parameter is utilized for determining the surface temperature, comprising:
utilizing at least two physical parameters of only the sheathed element glow plug to ascertain the surface temperature of the sheathed element glow plug, wherein the at least two physical parameters include one of:
a resistance of the sheathed element glow plug and a power drawn by the sheathed element glow plug,
the resistance of the sheathed element glow plug and an actual current of the sheathed element glow plug, and
the resistance of the sheathed element glow plug and a voltage of the sheathed element glow plug.

13. The method as recited in claim 12, further comprising measuring at least one of the at least two physical parameters at the sheathed element glow plug during an operation of the sheathed glow plug in order to ascertain the surface temperature of the sheathed element glow plug.

14. The method as recited in claim 12, further comprising calculating at least one of the two physical parameters of the sheathed element glow plug from at least one further physical parameter that is measured at the sheathed element glow plug during an operation of the sheathed glow plug.

15. The method as recited in claim 12, further comprising calculating at least one of the resistance of the sheathed element glow plug and the power drawn by the sheathed element glow plug is calculated from a measured current and a measured voltage of the sheathed element glow plug.

16. The method as recited in claim 12, further comprising correcting the ascertained surface temperature using a correction factor that is a function of at least one operating parameter of the internal combustion engine.

17. The method as recited in claim 16, wherein the at least one operating parameter includes at least one of an engine speed, an injection quantity, an air mass, and a charge pressure of the air mass of the internal combustion engine.

18. The method as recited in claim 12, wherein the ascertained surface temperature of the sheathed element glow plug is used as actual temperature for a temperature control of the sheathed element glow plug.

19. A device for determining a surface temperature of a sheathed element glow plug in an internal combustion engine, in which a physical parameter is utilized for ascertaining the surface temperature, comprising:
an arrangement for utilizing at least two physical parameters of only the sheathed element glow plug to ascertain the surface temperature of the sheathed element glow plug, wherein the at least two physical parameters include one of:
a resistance of the sheathed element glow plug and a power drawn by the sheathed element glow plug,
the resistance of the sheathed element glow plug and an actual current of the sheathed element glow plug, and
the resistance of the sheathed element glow plug and a voltage of the sheathed element glow plug.

20. The device as recited in claim 19, further comprising:
a control unit connected to the sheathed element glow plug projecting into a combustion chamber of the internal combustion engine, the control unit ascertaining the at least two physical parameters.
